(19) United States
(12) Patent Application Publication
(10) Pub. No.: US 2015/0203403 A1
(43) Pub. Date: Jul. 23, 2015

(54) METHOD OF PRODUCING HYDRATION-ACCELERATING SEEDS TO BE USED AS AN ADDITIVE FOR CEMENT AND/OR CONCRETE

(71) Applicant: THYSSENKRUPP INDUSTRIAL SOLUTIONS AG, Essen (DE)

(72) Inventor: Michael Enders, Munster (DE)

(73) Assignee: THYSSENKRUPP INDUSTRIAL SOLUTIONS AG, Essen (DE)

(21) Appl. No.: 14/416,919

(22) PCT Filed: Jul. 19, 2013
(86) PCT No.: PCT/EP2013/065280

§ 371 Date: Jan. 23, 2015

(30) Foreign Application Priority Data
Jul. 23, 2012 (DE) 10 2012 106 658.

(51) Int. Cl. C04B 22/10; C04B 22/00; C04B 22/06

(52) U.S. Cl. CPC C04B 22/10; C04B 22/064; C04B 22/0086; C04B 2103/10

(57) ABSTRACT

In accordance with the invention, hydration-accelerating seeds composed of CSH phases or AFt/AFM phases or hemicarbonate or monocarbonate phases, or of a mixture of two or more of these phases, are used as an admixture for cement and/or concrete, the hydration-accelerating seeds having been obtained as follows:

a. using hot meal and/or bypass dust from a cement production operation as starting material,
b. producing a suspension by mixing the starting material with an aqueous solution, until a solid consisting of hydration-accelerating seeds is formed, and
c. removing the solid consisting of hydration-accelerating seeds from the aqueous solution.

The invention relates to the use of hydration-accelerating seeds composed of CSH phases or AFt/AFM phases or hemicarbonate or monocarbonate phases, or of a mixture of two or more of these phases.

In the hydration of cement, the various cement clinker phases react with water substantially to form the hardened cement phases calcium silicate hydrate, ettringite, calcium aluminate ferrite phases, monosulphate and portlandite.

WO 2010026155 A1 discloses accelerating cement hydration by adding CSH seeds to cement or in concrete. The development of strength by a cement can be accelerated through the addition of such CSH seeds. In this case the addition of seeds reduces the activation energy for component reactions in the cement hydration. These seeds, moreover, serve as seeds for the reformation of the CSH phase. In the production of the CSH seeds in accordance with WO 2010026155 A1, a water-soluble calcium component reacts with a water-soluble silicon component in an aqueous solution which further comprises a water-soluble comb polymer, which is a suitable plasticizer for hydraulic binders.

EP 1 923 366 A1 describes a method for working up bypass dusts, in which the bypass dusts are brought into contact with an aqueous phase and then solid and insoluble constituents are removed.

DE 694 07 418 T2 discloses a solidification and curing accelerator for silicatic, hydraulic binders, which originates in particular from the hydration of synthetic Portland cements, comminuted Portland clinkers or composite Portland cements, or mixtures of the aforementioned starting materials.

The products available on the market with hydration-accelerating seeds, however, are relatively expensive, thereby limiting the possibilities for use.

It is an object of the invention, therefore, to specify a new use for hydration-accelerating seeds composed of CSH phases or AFt/AFM phases or hemicarbonate or monocarbonate phases, or of a mixture of two or more of these phases, whose production complexity and production costs can be reduced.

In accordance with the invention, this object is achieved through the features of Claim 1, by using hydration-accelerating seeds composed of CSH phases or AFt/AFM phases or hemicarbonate or monocarbonate phases, or of a mixture of two or more of these phases, as an admixture for cement and/or concrete, the hydration-accelerating seeds having been obtained as follows:

a. using hot meal and/or bypass dust from a cement production operation as starting material,
b. producing a suspension by mixing the starting material with an aqueous solution, until a solid consisting of hydration-accelerating seeds is formed, and
c. removing the solid consisting of hydration-accelerating seeds from the aqueous solution.

Using intermediates in the cement production operation constitutes a comparatively inexpensive means of providing the starting material. Hydration-accelerating seeds can therefore be obtained as a by-product in cement production.

Further embodiments of the invention are subject matter of the dependent claims.

In process step b), the mixing takes place preferably by continuous stirring, it being useful for this mixing to be carried out in a reactor in a temperature range from 5 to 200° C., preferably from 15 to 80° C. It has further proven to be advantageous if the pH of the suspension is adjusted in a range from 10 to 14, more particularly by appropriately adapting the proportion of starting material to aqueous solution.

Higher temperatures accelerate the growth of the hydration-accelerating seeds, provided that a critical, phase-specific, upper temperature limit is not exceeded. Through a suitable selection of the reaction time and of the temperature in the reactor, moreover, depending on the mineralogical/chemical composition of the starting materials, hydration-accelerating seeds of a defined composition and size can be produced in a targeted way. It may be necessary, furthermore, for process step b) to be carried out in an inert gas atmosphere, more particularly in the absence of CO₂, in order to prevent the formation of calcium carbonate.

Bringing about the desired mixture of the phases indicated above is accomplished through external parameters, such as the temperature in the reactor and/or the pH concentration of the chemical constituents in the solution.

Where the starting material also includes inert materials, such as quartz or iron ore, for example, the possibility exists of taking out these inert materials during or after process step b), in order thereby to regulate the amount and quality of the hydration-accelerating seeds in the end product. In process step b), inert material, such as quartz and iron ore, will settle out as sediment, and can then be taken out easily.

After process step c), the seeds removed may still have residual moisture contents of less than 15 wt %, preferably of less than 10 wt %, very preferably of less than 7 wt %.

Also possible, however, is the removal of this inert material together with the resulting seeds, as solid, from the aqueous solution. Removing the solid from the aqueous solution is carried out, for example, in a hydrocyclone or a filter press. The aqueous solution remaining in process step c) may be used at least partly again as aqueous solution in process step b). The aqueous solution remaining after process step c) normally has a loading of soluble constituents and/or pollutants from the starting material, and so it is useful to take out at least part of the aqueous solution and subject it to removal of soluble constituents or pollutants.

The solid removed in process step c) may be comminuted further by grinding, with or without any inert material. For the use of the hydration-accelerating seeds as an admixture for cement and/or concrete, a useful particle size has proved to lie in the range from 10 nm to 20 μm.

Further advantages and embodiments of the invention will be detailed below, with reference to the description hereinafter and the drawing.

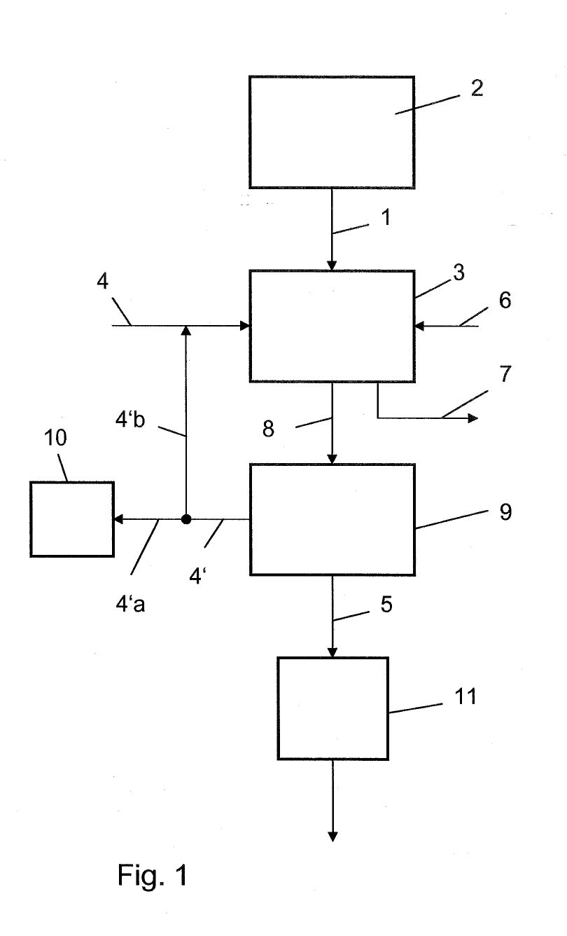

FIG. 1 shows a schematic flow diagram of the process for producing the hydration-accelerating seeds.

Employed as starting material 1 are intermediates from a cement production operation 2. These intermediates may be hot meal and/or bypass dust. The starting material is taken out at suitable points from the cement production operation, and fed to a reactor 3, where a suspension is prepared by mixing the starting material 1 with an aqueous solution 4, by continuous stirring, until a solid 5 consisting of hydration-accelerating seeds is formed. This process step may take up to several days.

As a result of the free lime from the starting material 1, a pH of between 10 and 14 is established in the aqueous solution 4:

CaO+H₂=Ca(OH)₂ (1)

The particular phase composition of the starting material 1 triggers a hydration reaction, with hydration-accelerating seeds 5 forming in the aqueous solution 4 from the starting material (e.g. metakaolin, C2S, melt phase, C3S) together with the dissolved calcium hydroxide and water, in a process similar to the hydration of cement.

The purity of the starting material 1 varies. Depending on the reaction conversion, the temperature and the purity of the starting material, a partial to complete conversion to form the hydration-accelerating seeds composed of CSH phases and/or AFt/AFM phases and/or hemicarbonate or monocarbonate phases may be achieved. It is also possible for the nature and amount of the hydration products to be determined partly or wholly through prior selection of the temperature in the reactor, of the composition of the starting materials and of the stability ranges of the hydration products. In this context, the following reactions occur in particular:

CSH phase:

3CaO*SiO₂+5.3H₂O=1.7CaO—SiO₂—4H₂O+1.3Ca(OH)₂ (2)

1.7Ca(OH)₂+SiO₂+4H₂O==1.7CaO—SiO₂—4H₂O (3)

AFt/AFM phase:

Ca₃Al₂O₆+32H₂O+3CaSO₄=(CaO)₆(Al₂O₃)(SO₃)₃*32H₂O (4)

Ca₃Al₂O₆+12H₂O+CaSO₄=Ca₄Al₂(SO₄)(OH)₁₂*6H₂O (5)

Hemicarbonate or monocarbonate phase:

Ca₃Al₂O₆+11H₂O+CaCO₃=Ca₄Al₂(CO₃)(OH)₁₂*5H₂O (6)

2Ca₃Al₂O₆+23H₂O+Ca(OH)₂+CaCO₃=2Ca₄Al₂(CO₃)_{0.5}(OH)₁₃*5.5H₂O (7)

Reaction with metaclays:

3.7Ca(OH)₂+Al₂Si₂O₅+12H₂O=Ca₂Al₂SiO₇*8H₂O+1.7CaO—SiO₂—4H₂O (8)

The reaction in the reactor 3 takes place preferably in an inert gas atmosphere, in order in particular to prevent the formation of calcium carbonate. Furthermore, the reaction conversion can be regulated in a targeted way through the setting of a particular temperature of the suspension and/or the alkalinity of the suspension. Depending on the starting material 1 available, the temperature in the reactor 3 will be set in the range from 5 to 200° C.

It has emerged as being useful, moreover, if the pH of the suspension in the reactor 3 is set in a range from 10 to 14. The pH is a measure of the proton content and hydroxyl ion content of an aqueous solution.

Setting the pH is accomplished easily by appropriately adapting the proportion of starting material 1 and aqueous solution 4. Hydrate phases are formed from the starting products of cementitous systems at pH levels above 10. Only then, for example, are there sufficient Ca²⁺ ions and HₙSiO4⁽⁴⁻ⁿ⁾ ions for the formation of CSH phases. On ingress of CO₂, CaCO₃ is formed. The lowering in pH which occurs in that case suppresses the formation of hydrate phases.

CaO+CO₂=CaCO₃ (9)

The stability ranges of the AFt phases and AFM phases, in particular, are characterized by an upper maximum temperature for phase formation at 40-50° C. Through prior selection of the reactor temperature, this upper temperature allows targeted setting of mineralogical compositions for the product composed of hydration-accelerating seeds, or else allows targeted production of hydration-accelerating seeds consisting primarily of CSH phases.

It is also conceivable for the reaction to be influenced by further adjuvants 6, such as slaked lime, alkali metal compounds, sulphate compounds or chlorides.

The course and the end of the reaction may be imaged directly, for example, by the availability of calcium, silicon or aluminium species in the aqueous solution 4. Analytical methods for this purpose are known in particular from cement chemistry (pore solution analysis). Other known methods for characterizing the progress of reaction and the quality of the product are x-ray diffraction methods and electron microscopy methods, by phase quantification in the hydration product and in the starting materials, or thermogravimetric measurements of the bound water.

Where the starting material 1 includes inert material, such as quartz or iron ore, for example, it may be desirable to remove this material from the hydration-accelerating seeds 5. This can be done, for example, by sedimentation in the reactor 3, with inert material 7 dropping downwards during stirring, owing to its nature, allowing it to be taken out there.

As soon as the hydration-accelerating seeds have formed, the suspension 8 is taken out from the reactor 3 and supplied to a facility 9 for removal of the hydration-accelerating seeds 5. The facility 9 is formed, for example, by a hydrocyclone or a filter press. The remaining aqueous solution 4′ will typically have a loading of soluble constituents and/or pollutants from the starting material 1, and so it is useful to take out at least part 4′a of the aqueous solution and supply it to a facility 10 for the removal of the soluble constituents or pollutants. The remaining part 4′b can be supplied again as aqueous solution to the reactor 3.

The hydration-accelerating seeds 5 removed in the facility 9 represent the desired end product. The seeds, in dry form or in liquid form as a suspension, may be added to cement or concrete, where they bring about an acceleration in cement hydration. Depending on the starting material, however, it may be desirable for the hydration-accelerating seeds 5 to be comminuted beforehand in a mill 11 to a particle size range of preferably 10 nm to 20 μm. The accelerating activity of the seeds added to the binder may be adapted via the fineness to the desired accelerating effect in the hydration of the binder. It is also possible for AFt phases to be mechanically destroyed in a targeted way by the grinding, in order to produce a product of hydration-accelerating seeds consisting primarily of CSH phases. Furthermore, via the size and number of the seeds, it is possible to influence the microstructure formation of the hydrated cement paste in such a way that the development of strength and durability corresponds more effectively to particular application requirements of the construction industry or other uses for binders.

1-12. (canceled)

13. A method of producing hydration-accelerating seeds of CSH phases or AFt/AFM phases or hemicarbonate or monocarbonate phases, or of a mixture of two or more of these phases, to be used as an additive for cement and/or concrete, comprising:
providing at least one of hot meal, bypass dust, or a mixture of hotmeal and bypass dust from a cement production operation to use as a starting material;
producing a suspension by mixing the starting material with an aqueous solution, until a solid comprising at least hydration-accelerating seeds is formed;
removing the solid hydration-accelerating seeds from the aqueous solution; and
comminuting the solid hydration-accelerating seeds by grinding.

14. The method of claim 13, wherein at least a portion of an aqueous solution remaining following said removing step, is used as at least a portion of the aqueous solution used in said producing step.

15. The method of claim 13, wherein said mixing is accomplished by continuous stirring.

16. The method of claim 13, further comprising, before said step of removing the solid hydration-accelerating seeds, removing inert materials sedimented during said mixing.

17. The method of claim 13, wherein said mixing is performed in a reactor in a temperature range of between about 5° C. to about 200° C.

18. The method of claim 13, wherein a pH of the suspension is between about 10 to about 14.

19. The method of claim 18, further comprising adjusting the pH of the suspension by changing a proportion of an amount of starting material to an amount of aqueous solution.

20. The method of claim 13, wherein said mixing is conducted in an inert gas atmosphere.

21. The method of claim 13, wherein said removing step is performed by the use of at least one of a hydrocyclone or a filter press.

22. The method of claim 13, wherein an aqueous solution remaining following said removing step has a loading of at least one of soluble constituents or pollutants from the starting material.

23. The method of claim 22, further comprising following said step of removing the solid hydration-accelerating seeds, removing at least a portion of the at least one of soluble constituents or pollutants from the aqueous solution remaining.
